(19) United States
(12) Patent Application Publication
(10) Pub. No.: US 2009/0143028 A1
(43) Pub. Date: Jun. 4, 2009

(54) APPARATUS AND METHOD FOR PROXIMITY SENSING USING TWO ANTENNAS

(75) Inventor: Tae Soo KIM, Seoul (KR)

Correspondence Address: Jefferson IP Law, LLP, 1730 M Street, NW, Suite 807, Washington, DC, 20036, US

(73) Assignee: Samsung Electronics Co. Ltd., Suwon-si (KR)

(21) Appl. No.: 12/173,534

(22) Filed: Jul. 15, 2008

(30) Foreign Application Priority Data
Dec. 3, 2007 (KR) 2007-0124188

(51) Int. Cl. H04B 1/40; H04B 17/00

(52) U.S. Cl. 455/90.2; 455/226.2

(57) ABSTRACT

An apparatus and a method for proximity sensing by using the difference between reception intensity changes of two antennas is provided. The method of proximity sensing includes detecting a reception signal intensity change while receiving a signal through an antenna during communications with another communication equipment, and identifying an approach of an object according to the detected reception intensity change.

### PRIORITY

This application claims the benefit under 35 U.S.C. §119(a) of a Korean patent application filed in the Korean Intellectual Property Office on Dec. 3, 2007 and assigned Serial No. 2007-0124188, the entire disclosure of which is hereby incorporated by reference.

### BACKGROUND OF THE INVENTION

1. Field of the Invention

The present invention relates to an apparatus and a method for proximity sensing. More particularly, the present invention relates to an apparatus and a method for proximity sensing using a difference between reception intensity changes of two antennas.

2. Description of the Related Art

Recently, technical development and application of proximity sensors are rapidly expanding. A proximity sensor outputs an on/off signal by detecting an object upon approaching a detectable range preset by the proximity sensor without using any mechanical contact, and not by outputting an on/off signal by detecting a mechanical contact.

The operation of the proximity sensor is based on the following principle. If an object approaches a detecting surface of the proximity sensor while a stationary radio frequency wave is being generated by an oscillator, the amplitude of the radio frequency wave is reduced or the generation of the radio frequency by the oscillator is interrupted. The change of the amplitude of the radio frequency wave is then converted into an electrical signal to determine the presence of the approaching object.

If any non-metallic stationary material is located between the proximity sensor having a radio frequency oscillator and the approaching object, the proximity sensor can nevertheless detect the presence of the object without being interfered by the material.

Various functions of a mobile terminal can be controlled by installing a proximity sensor having such a function in a mobile terminal. For example, while communicating through a mobile terminal, if the mobile terminal approaches and contacts a user's ear, the display unit of the mobile terminal may automatically be switched off by a proximity sensing function. Alternatively, while communicating through a mobile terminal, if the mobile terminal approaches and contacts a user's ear, the speaker volume of the mobile terminal may automatically be set to a preset value by the proximity sensing function. Therefore, this function may improve user convenience of the mobile terminal.

Conventional methods include a method of detecting a change of an electrical field as an object approaches, a method of emitting a specific frequency signal and detecting a signal reflected by an object as the object approaches, and a method of detecting a reduction of brightness through a hole formed on a mobile terminal as an object approaches.

However, the above methods have various problems in applying the proximity sensor to a mobile terminal. For example, the method of detecting a change of an electrical field has a problem in the efficiencies of installation space and power consumption, because the sizes of two electrodes generating the electrical field must be increased proportionally to the distance to the object, and because power consumption increases proportionally to the intensity of the electrical field applied between the two antennas.

The method of detecting a signal reflected by an object has a problem in providing a transparent window having a low reflection rate and a high transmission rate for an incident signal transmitted from outside. Additionally, this method is difficult to install a sensor in a limited space, because a transmitter for emitting a specific frequency signal and a receiver for receiving a reflected signal must be spatially isolated. Further, this method has a problem of consuming a large amount of power, because the specific frequency signal must continuously be emitted to enable detection of the signal reflected by the object.

The method of detecting reduction of the brightness through a hole formed on a mobile terminal has a disadvantage of requiring the provision of a hole for receiving light from outside. In particular, this method may induce a malfunction in detecting the presence of an object at night or in a dark place.

Accordingly, a need exits for development of a proximity sensor providing a new function to address the above problems in the application of a proximity switch to a mobile terminal.

### SUMMARY OF THE INVENTION

An aspect of the present invention is to address at least the above mentioned-problems and/or disadvantages and to provide at least the advantages described below. Accordingly, an aspect of the present invention is to provide an apparatus and a method for proximity sensing, in which two antennas are formed in a mobile terminal and the presence of an object is determined by detecting the difference between reception sensitivities of the two antennas.

An aspect of the present invention is to provide an apparatus and a method for proximity sensing having a proximity sensing function which uses a separate antenna for detecting a specific frequency signal transmitted by a transmitting station and determines the presence of an object by detecting the change of an impedance matching value of an antenna as the object approaches.

An aspect of the present invention is to provide an apparatus and a method for proximity sensing, enabling power consumption required for the proximity sensing function to be reduced by installing a dedicated antenna for reception of a specific frequency signal transmitted by a transmitting station.

An aspect of the present invention is to provide an apparatus and a method for proximity sensing, enabling a configuration of a mobile terminal to be simplified and the appearance of the mobile terminal to be improved by installing a separate antenna for proximity sensing in an Internal antenna (Intenna) form.

Still an aspect of the present invention is to provide an apparatus and a method for proximity sensing, enabling the difference between reception intensity changes of two antennas to be detected accurately by using a separate antenna dedicated for proximity sensing.

According to an aspect of the present invention, a method of proximity sensing in a mobile terminal is provided. The method includes detecting a reception signal intensity change while receiving a signal through an antenna during communications with another communication equipment, and identifying an approach of an object according to the detected reception intensity change.

According to another aspect of the present invention, a method of proximity sensing in a mobile terminal is provided. The method includes detecting impedance matching value changes of a main antenna and at least one sub antenna, determining reception signal intensity changes of the signals received through the main antenna and at least one sub antenna, comparing the reception signal intensity change of the main antenna with the reception signal intensity change of the at least one sub antenna, and controlling the operation of the mobile terminal according to the comparison result of the reception signal intensity changes.

According to still another aspect of the present invention, a mobile terminal is provided. The mobile terminal includes a main antenna and a first communication module for forming a communication channel with a network, and for transmitting and receiving a radio frequency signal in a preset frequency band, a sub antenna and a second communication module for forming a communication channel with the network, and for receiving a radio frequency signal in the preset frequency band, a memory unit for storing an application program related to the control of a proximity sensing function and for storing setting information related to operational control of proximity sensing, and for buffering the received signals through the main antenna and the sub antenna, and a control unit for controlling proximity sensing according to a difference between the reception signal intensity changes of the main antenna and the individual sub antenna.

According to an aspect of the present invention, whereas in the conventional art a transmitter and a receiver are required for proximity sensing, only a receiver for receiving a signal transmitted from the outside is required, and thereby electrical power consumption is reduced. Additionally, a proximity sensor according to exemplary embodiments of the present invention may be applied to a mobile terminal by using an Intenna and does not require a hole in the mobile terminal, thereby improving the appearance of the mobile terminal. Further, accurate proximity sensing is provided by detecting reception intensity changes of two antennas receiving a signal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will become more apparent from the following description taken in conjunction with the accompanying drawings, in which:

FIG. 1 is a block diagram illustrating a configuration of a mobile terminal according to an exemplary embodiment of the present invention; and

FIG. 2 is a flowchart illustrating a method of proximity sensing in a mobile terminal according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and structures will be omitted for clarity and conciseness.

A mobile terminal according to an exemplary embodiment of the present invention includes a main antenna for receiving a communication signal and a sub antenna for proximity sensing. By using these two antennas, an object (for example, a human body and a face) approaching the mobile terminal can be detected. That is, individual impedance matching values of the main antenna and the sub antenna change as the object approaches, and the intensity of signal received by each antenna changes as the object approaches. In an exemplary embodiment of the present invention, an object approaching a mobile terminal can be detected by using the difference of reception signal intensity changes between two antennas.

For this operation, a mobile terminal includes a sub antenna for detecting a specific frequency signal and means for measuring the intensity of the signal received by the sub antenna. The sub antenna can receive a signal in the substantially same frequency band as the main antenna.

The main antenna may be an antenna having a lower antenna characteristics change corresponding to an approach of an object, such as a folded inverted F antenna. The antenna characteristics include at least one of impedance, gain, and directivity. The sub antenna may be a dipole antenna, a monopole antenna, a patch antenna, a helical antenna, and the like. However, the sub antenna according to an exemplary embodiment of the present invention is not limited to the above examples, and may include any type of antenna that can be installed together with the main antenna in a small apparatus, such as in a mobile terminal, and can receive a signal in a specific frequency band from a transmitting station (for example, a base station). In an exemplary configuration, a helical antenna, whose characteristics change easily according to a change of the environment (for example, approach of an object), may be used as a sub antenna. Additionally, a shield may be formed around the sub antenna to provide a directional property to the sub antenna, so that the sub antenna can detect an approach direction of an object.

According to the designs of the main antenna and the sub antenna, the main antenna and the sub antenna may receive signals in the substantially same frequency band, or signals in different frequency bands. Because the mobile terminal is controlled according to the reception signal intensity change of the sub antenna in an exemplary embodiment of the present invention, the sub antenna may be an antenna that changes its frequency characteristics in a wide range corresponding to a change of the environment, regardless of the frequency band of the main antenna. Hereinafter, an example of the sub antenna and the main antenna receiving signals in the substantially same frequency band is described for the convenience in description.

Although only one sub antenna is illustrated in the description of the present invention, a plurality of sub antennas may also be applied according to an exemplary embodiment of the present invention.

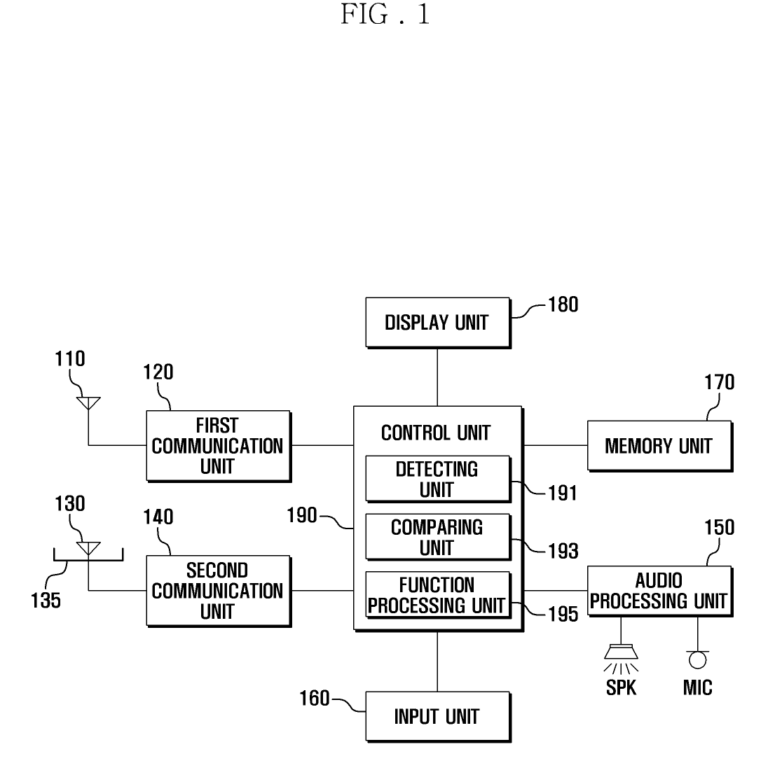

FIG. 1 is a block diagram illustrating a configuration of a mobile terminal according to an exemplary embodiment of the present invention.

Referring to FIG. 1, the mobile terminal includes a main antenna 110, first communication module 120, sub antenna 130, second communication module 140, audio processing unit 150, input unit 160, memory unit 170, display unit 180, and control unit 190.

The main antenna 110 and the first communication module 120 perform wireless communication of the mobile terminal. The first communication module 120 forms a communication channel with a network through the main antenna 110, and transmits and receives a Radio Frequency (RF) signal in a specific frequency band. The first communication module 120 may include an RF transmitter for amplifying a signal to be transmitted and for up-converting the frequency of the signal, and an RF receiver for low noise amplifying a received signal and for down-converting the frequency of the signal. In particular, an antenna that changes its frequency characteristics insensitively corresponding to approach of an object, such as a folded inverted F antenna, may be used as the main antenna 110.

The sub antenna 130 and the second communication module 140 also perform wireless communication of the mobile terminal. The second communication module 140 forms a communication channel with a network through the sub antenna 130, and receives an RF signal in a specific frequency band. The second communication module 140 may include an RF receiver for low noise amplifying a received signal and for down-converting the frequency of the signal. In particular, a shield 135 may be formed around the sub antenna 130 to provide a directional property to the sub antenna 130, so that the sub antenna can detect an approach direction of an object. An antenna that changes its frequency characteristics sensitively corresponding to approach of an object, such as a helical antenna, may be used as the sub antenna 130.

The audio processing unit 150 outputs a sound to a speaker (SPK) by converting a received audio signal to the sound, and outputs a digital audio signal to the control unit 190 by converting an audio signal received from a microphone (MIC) to a digital audio signal. The audio processing unit 150 may perform a preset operation according to the control of the control unit 190 using proximity sensing. For example, the intensity of an audio signal output may be controlled by the control unit 190.

The input unit 160 receives input of various character data from a user, and outputs key signals for initiating various functions and operation control of the mobile terminal to the control unit 190. The input unit 160 may be configured with a key pad having a plurality of keys, a touch pad, a touch screen, a combination thereof and the like.

The memory unit 170 stores application programs for the operation control of the mobile terminal, user data, data received from a network, and data generated during an execution of the application program. The memory unit 170 may include at least one buffer for temporarily storing data generated during the execution of the application programs.

In particular, the memory unit 170 stores an application program for operational control of the proximity sensing function. The application program may be a program processing a proximity sensing function by using the difference between reception intensity changes of the main antenna 110 and the sub antenna 130. For detecting approach of an object by the control unit 190, the memory unit 170 may store corresponding setting data for operational control of the control unit 190. Additionally, the memory unit 170 may buffer signals received through the main antenna 110 and the sub antenna 130, and provide the received signal according to a request from the control unit 190.

The display unit 180 outputs screen data generated during the execution of the application programs, a state of the user's key operation, and information of function settings. The display unit 180 may be configured with a Liquid Crystal Display (LCD), and the LCD may be a touch screen. If the display unit 180 is configured with a touch screen, the display unit 180 may operate as an input means. The display unit 180 may perform a preset operation according to the control of the control unit 190 using proximity sensing. For example, switching on/off of a display screen may be performed according to the control of the control unit 190.

The control unit 190 controls the general operation of the mobile terminal and internal signal flows in the mobile terminal. The control unit 190 may include a data processing unit configured with a codec and a modem.

In particular, the control unit 190 processes a proximity sensing function according to the difference between reception signal intensity changes of the main antenna 110 and the sub antenna 130. That is, the control unit 190 detects impedance matching value changes by checking a signal received through the main antenna 110 and the sub antenna 130. While detecting the impedance matching value changes, the control unit 190 compares the reception signal intensity changes of the main antenna 110 and the sub antenna 130, and determines an approach of an object according to the comparison result. Additionally, the control unit 190 may perform a preset control operation when the approach of an object is detected through the proximity sensing. For example, the control unit 190 may control the output of the audio processing unit 150 and the output of the display unit 180.

In order to perform this function, the control unit 190 includes a detecting unit 191, a comparing unit 193, and a function processing unit 195.

The detecting unit 191 detects matching value changes of the main antenna 110 and the sub antenna 130 from signals received through them.

When the detecting unit 191 detects matching value changes of the main antenna 110 and the sub antenna 130, the comparing unit 193 measures the reception signal intensity changes of the main antenna 110 and the sub antenna 130, then compares the reception signal intensity change of the main antenna 110 with the reception signal intensity change of the sub antenna 130.

The function processing unit 195 processes a preset function according to the comparison result of the comparing unit 193. If the reception signal intensity change of the sub antenna 130 is greater than the reception signal intensity change of the main antenna 110, the function processing unit 195 determines the object as approaching, and processes a corresponding function. For example, an audio signal output from the audio processing unit 150 and a screen data output from the display unit 180 may be controlled accordingly. If the reception signal intensity change of the sub antenna 130 is less than or equal to the reception signal intensity change of the main antenna 110, the control unit 190 may control a preset communication operation. For example, when the communication with a network is compromised, the control unit 190 may control a transmission power in order to maintain a connection with the network.

Although an exemplary embodiment of a mobile terminal is described having the configuration illustrated in FIG. 1, the mobile terminal according to the present invention is not limited to thereto. The mobile terminal according to an exemplary embodiment of the present invention may further include a camera module, electronic billing module, digital broadcast module, near field communication module, battery module, and the like. According to the design of the mobile terminal, a specific functional unit may be omitted or replaced with another functional unit.

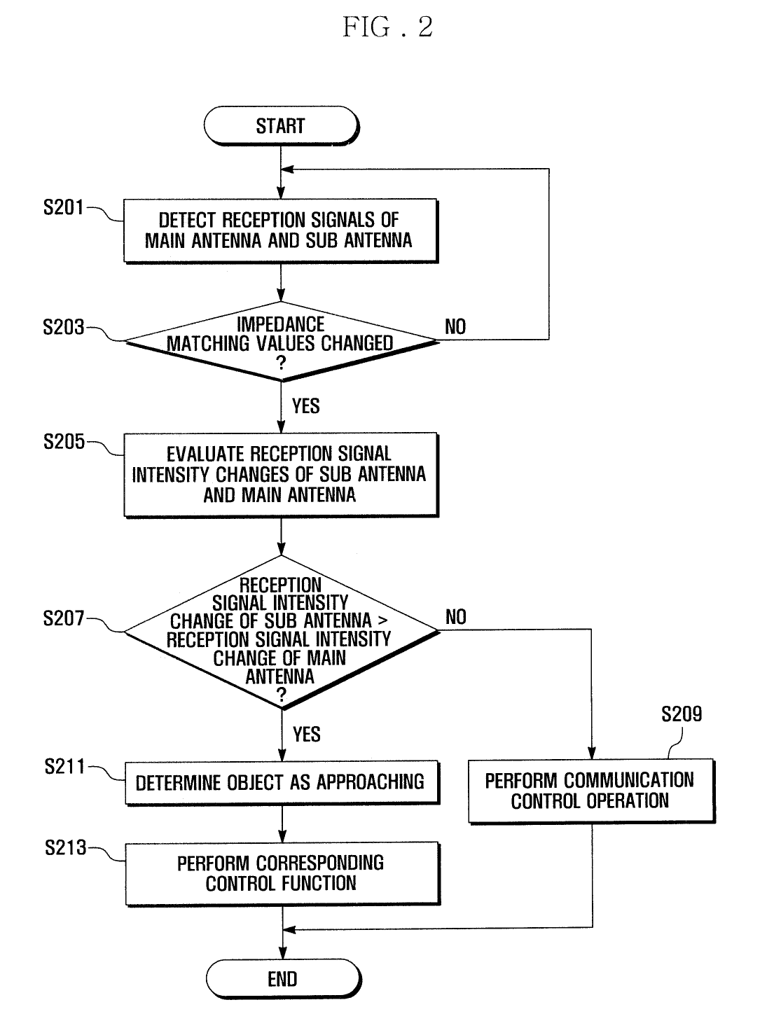

FIG. 2 is a flowchart illustrating a method of proximity sensing in a mobile terminal according to an exemplary embodiment of the present invention.

Referring to FIG. 2, the control unit detects that a signal is received through a main antenna and a sub antenna in step S201. Here, the main antenna and the sub antenna may receive signals in the substantially same frequency band. The control unit then determines whether impedance matching values of the antennas are changed in step S203.

If the impedance matching values of the antennas are changed, the control unit evaluates reception signal intensity changes of the main antenna and the sub antenna in step S205. The control unit then determines whether the reception signal intensity change of the sub antenna is greater than the reception signal intensity change of the main antenna in step S207.

If the reception signal intensity change of the sub antenna is less than or equal to the reception signal intensity change of the main antenna, the control unit controls a preset communication operation in step S209.

If the reception signal intensity change of the sub antenna is greater than the reception signal intensity change of the main antenna in step S207, the control unit determines that an object is approaching in step S211. Subsequently, the control unit controls a preset function corresponding to the approach of an object in step S213.

According to an exemplary embodiment of the present invention, the mobile terminal includes a main antenna for receiving a signal in a specific frequency band from a transmitting station (for example, a base station), and a sub antenna for receiving a signal in the substantially same frequency band as the main antenna and for changing an impedance matching value of the antenna when an object approaches. The sub antenna is installed in an Intenna form at a position of the mobile terminal that an object (for example, a portion of a user's body, such as a face) can easily approach.

If an object approaches the mobile terminal, a control unit of the mobile terminal detects matching value changes of the main antenna and the sub antenna. In particular, the sub antenna is characterized to have a greater reception signal intensity change than the main antenna. Accordingly, an exemplary embodiment of the present invention can detect an approach of an object by comparing the difference between reception signal intensity changes of the antennas. By using this function, the mobile terminal provides a more accurate and efficient proximity sensing function.

Although exemplary embodiments of the present invention have been described in detail hereinabove, it should be understood that many changes and modifications of the basic inventive concept herein described, which may appear to those skilled in the art, will still fall within the spirit and scope the exemplary embodiments of the present invention as defined in the appended claims and their equivalents.

What is claimed is:

1. A method of proximity sensing in a mobile terminal, the method comprising:
detecting a reception signal intensity change while receiving a signal through an antenna during communications with another communication equipment; and
identifying an approach of an object according to the detected reception intensity change.

2. The method of claim 1, wherein the antenna comprises a main antenna and a sub antenna, and the reception signal intensity change is detected by comparing the reception signal intensity change of the main antenna with the reception signal intensity change of the sub antenna, wherein the approach of the object is identified if the reception signal intensity change of the sub antenna is greater than the reception signal intensity change of the main antenna.

3. The method of claim 2, wherein the comparing of the reception signal intensity change of the main antenna with the reception signal intensity change of the sub antenna comprises:
determining the reception signal intensity change of the main antenna and the reception signal intensity change of the sub antenna; and
comparing the reception signal intensity change of the main antenna with the reception signal intensity change of the sub antenna.

4. The method of claim 3, wherein the comparing of the reception signal intensity change of the main antenna with the reception signal intensity change of the sub antenna comprises comparing an impedance matching value change of the main antenna with an impedance matching value change of the sub antenna.

5. The method of claim 4, wherein the main antenna and the sub antenna receive signals in the substantially same frequency band.

6. The method of claim 4, wherein the main antenna and the sub antenna receive signals in different frequency bands.

7. The method of claim 2, wherein, if the approach of an object is identified, a corresponding control operation is performed.

8. A method of proximity sensing in a mobile terminal, the method comprising:
determining a reception signal intensity change from a signal received through each of a main antenna and at least one sub antenna;
comparing the reception signal intensity change of the main antenna with the reception signal intensity change of the at least one sub antenna; and
controlling an operation of the mobile terminal according to the comparison result of the reception signal intensity changes.

9. The method of claim 8, wherein, if the reception signal intensity change of the at least one sub antenna is greater than the reception signal intensity change of the main antenna, an object is determined to be approaching and a corresponding control operation is performed.

10. The method of claim 9, wherein, if all the reception signal intensity changes of the at least one sub antenna are greater than or equal to the reception signal intensity change of the main antenna, a preset communication control operation is performed.

11. The method of claim 9, wherein the main antenna and the sub antenna receive signals in the substantially same frequency band.

12. The method of claim 9, wherein the main antenna and the sub antenna receive signals in different frequency bands.

13. A mobile terminal, the mobile terminal comprising:
a main antenna and a first communication module for forming a communication channel with a network, and for transmitting and receiving a radio frequency signal in a preset frequency band;
a sub antenna and a second communication module for forming a communication channel with the network, and for receiving a radio frequency signal in the preset frequency band;
a memory unit for storing an application program related to the control of a proximity sensing function and for storing setting information related to operational control of proximity sensing, and for buffering signals received through the main antenna and the sub antenna; and
a control unit for controlling the proximity sensing according to a difference between the reception signal sensitivity changes of the main antenna and the individual sub antenna.

14. The mobile terminal of claim 13, wherein the control unit detects impedance matching value changes from the signals received through the main antenna and the sub antenna, and if an impedance matching value change is detected, compares the reception signal intensity change of the main antenna with the reception signal intensity change of the sub antenna.

15. The mobile terminal of claim 14, wherein the control unit comprises:
a detecting unit for detecting reception signal intensity changes of the main antenna and the sub antenna;
a comparing unit for comparing the reception signal intensity change of the main antenna with the reception signal intensity change of the sub antenna; and
a function processing unit for processing a preset function according to the comparison result of the comparing unit.

16. The mobile terminal of claim 15, wherein, if the reception signal intensity change of the sub antenna is greater than the reception signal intensity change of the main antenna, the function processing unit determines that an object is approaching and processes a corresponding control operation, and if the reception signal intensity change of the sub antenna is less than or equal to the reception signal intensity change of the main antenna, the function processing unit processes a preset communication control operation.

17. The mobile terminal of claim 14, wherein the main antenna and the sub antenna receive signals in the substantially same frequency band.

18. The mobile terminal of claim 14, wherein the main antenna and the sub antenna receive signals in different frequency bands.

19. The mobile terminal of claim 14, wherein the sub antenna changes at least one of its antenna characteristics according to a change of an environmental condition.

20. The mobile terminal of claim 19, wherein the at least one of antenna characteristics comprises at least one of impedance, gain, and directivity.

21. The mobile terminal of claim 13, further comprising a shield around the sub antenna to provide a directional property to the sub antenna.

22. The mobile terminal of claim 13, wherein the sub antennal comprises at least one of a dipole antenna, a monopole antenna, a patch antenna and a helical antenna.

23. The mobile terminal of claim 13, wherein the application program comprises a program for processing a proximity sensing function according to the difference between the reception signal intensity change of the main antenna and the reception signal intensity change of the sub antenna.
